(19) United States
(12) Patent Application Publication
(10) Pub. No.: US 2023/0313051 A1
(43) Pub. Date: Oct. 5, 2023

(54) SYSTEMS AND METHODS TO USE STEAM TO BREAK EMULSIONS IN CRUDE

(71) Applicant: Saudi Arabian Oil Company, Dhahran (SA)

(72) Inventor: Nagoorpitchai S. Meeranpillai, Al Khobar (SA)

(21) Appl. No.: 17/712,624

(22) Filed: Apr. 4, 2022

(51) Int. Cl. C10G 31/08; C10G 31/06; C10G 33/06

(52) U.S. Cl. CPC C10G 31/08; C10G 31/06; C10G 33/06; C10G 2300/1033; C10G 2300/807

(57) ABSTRACT

Systems and methods for providing steam to crude prior to the crude reaching a gas oil separation plant (GOSP). The steam can help separate water and/or salt from the crude by breaking emulsions.

### FIELD

The disclosure generally relates to systems and methods to use steam to break emulsions in crude, such as using direct steam injection into the crude to break the emulsions in the crude upstream of a gas oil separation plant (GOSP).

### BACKGROUND

Often, crude is produced with formation water such that the crude contains water. It is generally desirable to separate the water from the crude. In some cases, the water is present in the crude in the form of emulsions, which can be difficult to separate from the crude.

### SUMMARY

In general, the disclosure seeks to provide an improved approach for treating crude to separate water in the crude from the crude, particularly via the use of steam. In some embodiments, the steam is directly injected into the crude to break the emulsions before the crude reaches a GOSP. In certain embodiments, the systems and methods can reduce bottlenecking in the GOSP, reduce operational difficulties at upstream and downstream process facilities, reduce equipment shutdowns, improve water separation from the crude upstream of the GOSP, and/or improve salt removal from the crude upstream of the GOSP, compared to conventional heat treatment approaches used to break emulsions. In some embodiments, the systems and methods according to the disclosure can use less energy to break emulsions compared with conventional heat treatment approaches. In certain embodiments, the systems and methods can reduce costs and/or energy consumption associated with emulsions in a GOSP, such as by reducing and/or avoiding operation delays and reducing and/or avoiding the use of additional treatments to break emulsions. In some embodiments, the systems and methods can be used to provide an increased flow rate of crude to the GOSP. In certain embodiments, the systems and methods can result in higher production of crude, improved produced water quality and/or improved environmental protection compared to conventional heat treatment approaches used to break emulsions. In certain embodiments, interacting steam with the crude enables the GOSP to handle crude which, prior to the steam treatment, has a relatively high water content and/or a relatively high salt content.

In some embodiments, steam is added to the crude by injection into a conduit upstream of the GOSP. In certain embodiments, the conduit is a pipe. In some embodiments, the conduit is a flow line. In certain embodiments, the conduit is an offshore trunk-line. In certain embodiments, the conduit is directly connected to a GOSP inlet. In some embodiments, the conduit is an offshore trunk-line directly connected to a GOSP inlet. In certain embodiments, the steam interacts with the crude in the conduit before the crude reaches the GOSP inlet.

In some embodiments, a pre-existing component of the GOSP can provide heat to the steam source to generate steam. In such embodiments, an additional source of heat for the steam source is not involved. In some embodiments, a burner in the GOSP can provide heat to the steam source to generate steam. In certain embodiments, boiler feed water within the GOSP can be used as the steam source.

In a first aspect, the disclosure provides a system that includes: a GOSP including an inlet; a conduit in fluid communication with the GOSP inlet; and a steam source configured to provide steam to the conduit so that, during use of the system, steam from the steam source interacts with crude in the conduit before the crude reaches the GOSP inlet.

In some embodiments, the system is configured so that the steam breaks emulsions present in the crude.

In some embodiments, the conduit is directly connected to the GOSP inlet.

In some embodiments, the conduit is an offshore trunk line.

In some embodiments, the steam source is a component of the GOSP.

In some embodiments, the GOSP includes a burner configured to provide heat to the steam source to generate the steam.

In some embodiments, the GOSP includes: a trap including an inlet in fluid communication with the conduit, the trap including a member selected from the group consisting of a high pressure production trap and a low pressure production trap; a degassing tank having an inlet in fluid communication with an outlet of the trap; and a dry oil tank having an inlet in fluid communication with an outlet of the degassing tank. In some embodiments, the GOSP further includes at least one member selected from a dehydrator and a desalter, wherein the at least one member is between the outlet of the degassing tank and the inlet of the dry oil tank. In some embodiments, the steam source is a component of the GOSP. In some embodiments, the conduit is an offshore trunk line that is directly connected to the GOSP inlet.

In some embodiments, the system is configured so that, during use of the system, the steam heats the crude in the conduit to a temperature of at least 125° F.

In some embodiments, the system is configured so that during use of the system: before the steam is provided to the crude, the crude has a first water content; after the stream is provided to the crude, the crude has a second water content; and the second water content is at most 30% of the first water content.

In some embodiments, the system is configured so that, during use of the system after the stream is provided to the crude, the crude has a salt content of at most 10 parts per thousand barrels.

In another aspect, the disclosure provides a method that includes: providing steam to crude; and after providing the steam to the crude, providing the crude to a GOSP.

In some embodiments, providing the steam to the crude breaks emulsions in the crude.

In some embodiments, breaking the emulsions in the crude separates water and salt from the crude.

In some embodiments, providing the steam to the crude separates water from the crude.

In some embodiments, providing the steam separates salt from the crude.

In some embodiments, providing the steam to the crude includes injecting the steam into the crude.

In some embodiments, providing the steam to the crude heats the crude to a temperature of at least 125° F.

### BRIEF DESCRIPTION OF THE FIGURES

FIG. 1 is a schematic for an embodiment of the system;

FIG. 2 is a graph showing experimental data; and

FIG. 3 is a graph showing experimental data.

### DETAILED DESCRIPTION

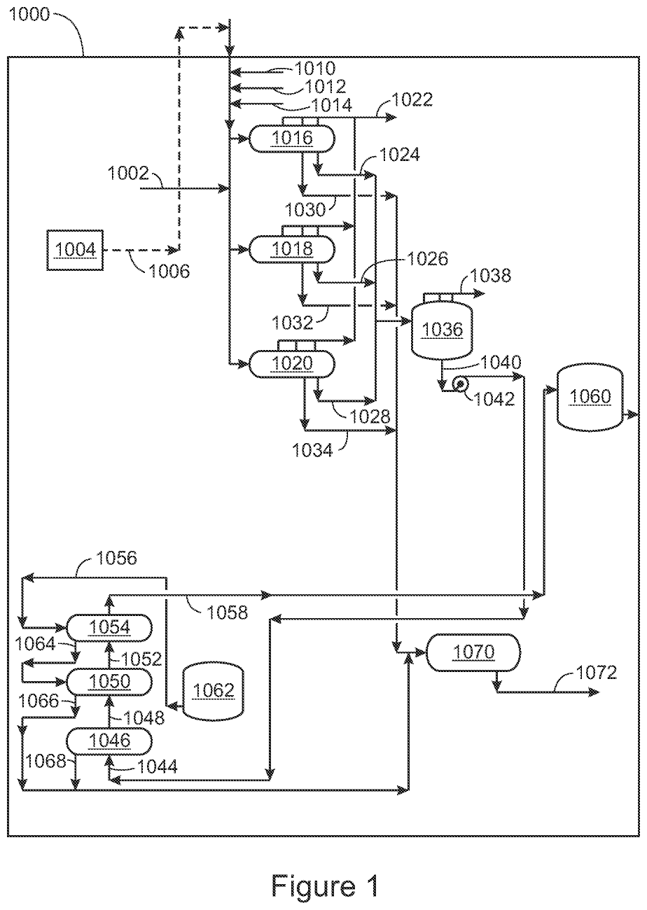

FIG. 1 schematically shows certain components of an embodiment of a gas oil separation plant (GOSP) 1000 that is connected to an offshore trunk-line 1002 carrying a fluid that contains crude, gas and water. Typically, water is present in the crude in the form of emulsions. In addition, the crude can contain salt. In some cases, the salt is contained within the water that is contained within the crude.

The GOSP includes a boiler 1004 connected to the trunk-line 1002 via a line 1006 such that steam produced by the boiler 1004 is injected directly into the crude at a region of the trunk-line 1002 that is outside the GOSP 1000. Optionally, the heat used by the boiler 1004 to generate the steam can be provided by a pre-existing component of the GOSP 1000. As an example, the heat can be provided by a burner present within the GOSP 1000. In some embodiments, boiler feed water within the GOSP 1000 can be used as the steam source. As discussed in more detail below, the steam can break the emulsions in the crude, which can help separate the water from the crude and also can help reduce the salt content of the crude.

Within the GOSP 1000, the trunk-line 1002 is connected to a demulsifier unit 1010, a corrosion inhibitor unit 1012 and a scale inhibitor unit 1014 so that the demulsifier, the corrosion inhibitor and/or the scale inhibitor can be added to the fluid. In general, the demulsifier can help further separate the water from the crude, while the corrosion inhibitor and scale inhibitor can help protect components of the GOSP 1000 to enhance longevity of the components.

Further downstream, the trunk-line 1002 is connected to traps 1016, 1018 and 1020, which may be, for example, high pressure production traps (HTTPs) and/or low pressure production traps (LPPTs). The traps 1016, 1018 and 1020 at least partially separate the gas, crude and water from each other.

The at least partially separated gas is sent from the traps 1016, 1018 and 1020 to an outlet 1022.

The at least partially separated water leaves the traps 1016, 1018 and 1020 along lines 1030, 1032, 1034, respectively, and enters to a water-oil separator (WOSEP) 1070, which at least partially separates remaining crude from the water. The resulting water goes to an outlet 1072.

In some embodiments, the resulting water is salt water. In certain embodiments, the resulting water is ultimately injected into wells.

The at least partially separated crude leaves the traps 1016, 1018 and 1020 via lines 1024, 1026 and 1028, respectively, and enters a degassing tank 1036. The degassing tank 1036 at least partially separates remaining gas from the crude. The gas is sent from the degassing tank 1036 to an outlet 1038. The crude travels from the degassing tank 1036 along a line 1040 to a charge pump 1042 and from the charge pump 1042 along a line 1044 to dehydrator 1046. The dehydrator 1046 at least partially separates remaining water from the crude. The separated water leaves the dehydrator 1046 along line 1068 and goes to the WOSEP 1070. The crude travels from the dehydrator 1046 along a line 1048 to a first stage desalter 1050 and from the first stage desalter 1050 to a second stage desalter 1054 along a line 1052. At the same, distilled water travels from a tank 1062 to the second stage desalter 1054, from the second stage desalter 1054 to the first stage desalter along a line 1064, and from the first stage desalter 1046 to the WOSEP 1070 along a line 1066. With this arrangement, the desalter stages 1050 and 1054 reduce the salt content of the crude, which ultimately travels from the second stage desalter 1054 to a dry oil tank 1060.

While FIG. 1 schematically shows an embodiment of a GOSP, it is to be understood that the disclosure is not limited to such a GOSP. As an example, according to the disclosure, the components of a GOSP can be arranged in any appropriate order. In some embodiments, one or more components depicted in FIG. 1 can be removed from a GOSP, as appropriate. In certain embodiments, one or more components not depicted in FIG. 1 can be included in a GOSP, as appropriate. In some embodiments, for any particular component depicted in FIG. 1, more or less occurrences of the component are possible, as appropriate. In certain embodiments, the flow path of one or more fluids within a GOSP can differ from that depicted in FIG. 1, as appropriate.

Without wishing to be bound by theory, it is believed that the rate of crude and water separation generally increases with temperature due to an increased rate of collision of water droplets and a decreased viscosity of emulsions. However, excess increases in temperature may be undesirable because they may cause the loss of light ends in the crude resulting in higher density and viscosity of the crude.

Without wishing to be bound by theory, it is believed that, compared to external heating of crude, direct steam injection to pipelines will improve heating efficiency by relatively quick (e.g., instant) heat dissipation.

Without wishing to be bound by theory, it is believed that, compared to external heating of crude, steam injection heating of crude to the same temperature may be superior (e.g., better separation of crude from water, and/or decreased salt content in the crude) due to a reduction in viscosity of the crude and increased droplet collisions caused by the addition of water from the steam. It is further believed that the increased droplet collisions may result in increased coalescence and salt reduction.

In some embodiments, heating crude with steam separates water from the crude. For example, in certain embodiments, heating crude with steam to a temperature of at least 125° F. (e.g. at least 130° F., at least 135° F., at least 140° F., at least 145° F.) and at most 150° F. results in at least 70% (e.g. at least 75%, at least 80%, at least 85%, at least 90%, at least 95%) of the water present in the crude before heating being separated from the crude.

In certain embodiments, heating crude with steam reduces the water content of the crude. For example, in certain embodiments, after crude is heated with steam to a temperature of at least 125° F. (e.g. at least 130° F., at least 135° F., at least 140° F., at least 145° F.) and at most 150° F., the crude has a water content that is at most 30% (e.g. at most 25%, at most 20%, at most 15%, at most 10%, at most 5%) of the water content of the crude prior to the crude being heated with steam.

In certain embodiments, heating crude with steam enhances water separation from the crude compared to heating the crude to the same temperature without using steam. For example, in some embodiments, crude heated with steam to a temperature of at least 125° F. (e.g. at least 130° F., at least 135° F., at least 140° F., at least 145° F.) and at most 150° F. results at least 10% (e.g., at least 20%, at least 30%, at least 40%, at least 50%) more water being separated from the crude compared to the amount of water separated from the crude when the crude is heated to the same temperature without using steam.

In certain embodiments, heating crude with steam decreases the salt content of the crude. For example, in some embodiments, crude heated with steam to a temperature of at least 125° F. (e.g. at least 130° F., at least 135° F., at least 140° F., at least 145° F.) and at most 150° F. results in the crude having a salt content of at most 10 parts per thousand barrels (ptb) (e.g., at most 9 ptb, at most 8 ptb, at most 7 ptb, at most 6 ptb, at most 5 ptb, at most 4 ptb, at most 3 ptb, at most 2 ptb, at most 1 ptb).

In certain embodiments, heating crude with steam results in enhanced salt removal from the crude compared to heating the crude to the same temperature without using steam. For example, in some embodiments, crude heated with steam to a temperature of at least 125° F. (e.g. at least 130° F., at least 135° F., at least 140° F., at least 145° F.) and at most 150° F. results in the crude having a salt content that is at most 80% (e.g., at most 75%, at most 70%, at most 65%, at most 60%, at most 55%, at most 50%) of the salt content in the crude when the crude is heated to the same temperature without using steam.

### Examples

Arabian medium crude was tested to study the effects of different heating methods on crude-water separation and salt content. Samples were heated using one of: a water bath heated to 100° F.; a water bath heated to 125° F.; or saturated steam injection to heat the sample to 125° F.

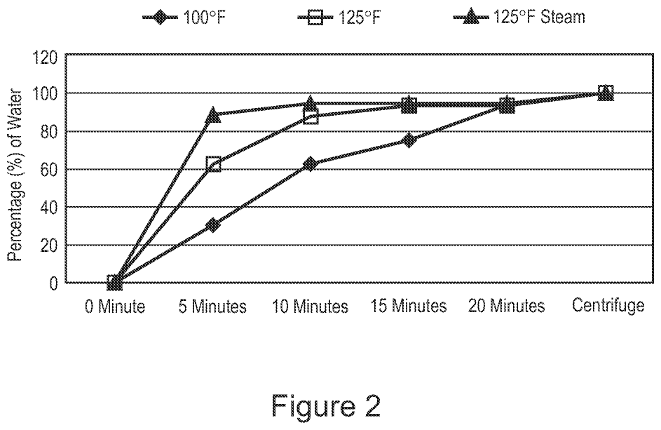

FIG. 2 shows the percentage of water initially present in the crude that was separated from the crude over time for the three different heating techniques. For each data point in FIG. 2, the sample was disposed in a graduated centrifuge glass tube, and, after heating the emulsion, the water separation was observed in the graduated centrifuge glass tube at five minute intervals with the naked eye. Heating the crude to 125° F. using steam caused greater water separation over shorter periods of time compared to heating to the same temperature using a water bath. For example, heating the crude to 125° F. using steam for five minutes resulted in approximately 25% more water being separated from the crude compared with heating the crude to the same temperature for the same amount of time using water bath heating. After heating, the samples were centrifuged to completely separate the crude and water.

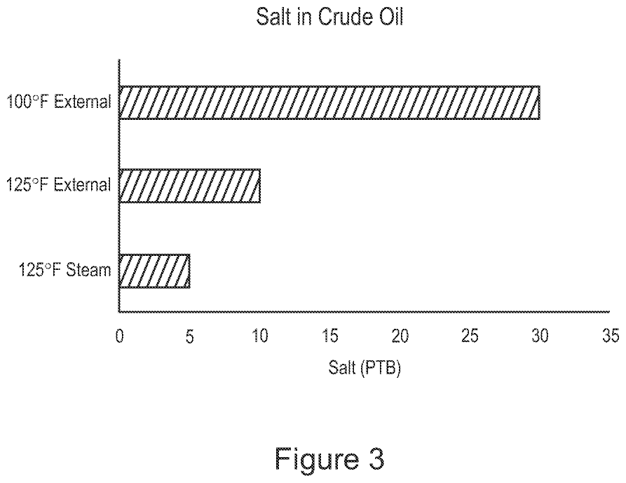

FIG. 3 shows the salt content in the crude after heating the crude for 20 minutes using the three different heating techniques noted in the preceding paragraph. The salt content was determined using the ASTM D3230 Standard Test Method for Salt in Crude Oils by Electrical Conductivity. An alcoholic mixture of methanol-butanol and distilled water was mixed with the crude, and the electrical conductivity was then measured. The electrical conductivity depended on the concentration of chloride in the crude. Heating with steam to 125° F. results in a salt content of the crude that is approximately 50% compared with the salt content of the crude after heating the crude to the same temperature for the same amount of time using a water bath.

### Other Embodiments

While only certain embodiments have been disclosed, the disclosure is not limited to such embodiments.

As an example, in some embodiments the steam source and crude in the conduit before the GOSP inlet can be connected indirectly. In some embodiments, the steam source and the crude can be connected by at least two (e.g. at least three, at least four, at least 5) conduits.

In some embodiments, steam injection heating may be used in other processes and systems in the petroleum industry. As an example, steam can be injected into crude to stabilize the crude by stripping off natural gas and/or hydrogen sulfide from the crude. As another example, steam can be injected into a heavy oil reservoir to lift crude to the surface.

1. A system, comprising:
a gas oil separation plant (GOSP) configured to treat a first fluid comprising crude, gas and water to at least partially separate the crude, the gas and the water from each other, the GOSP comprising an inlet;
a conduit in fluid communication with the GOSP inlet; and
a steam source configured to provide steam to the conduit so that, during use of the system, steam from the steam source interacts with crude in the conduit before the crude reaches the GOSP inlet,
wherein the GOSP comprises:
a production trap comprising an inlet in fluid communication with the conduit;
a degassing tank comprising an inlet in fluid communication with an outlet of the production trap; and
a dry oil tank comprising an inlet in fluid communication with an outlet of the degassing tank.

2. The system of claim 1, wherein the system is configured so that the steam breaks emulsions present in the crude.

3. The system of claim 1, wherein the conduit is directly connected to the GOSP inlet.

4. The system of claim 1, wherein the conduit is an offshore trunk line.

5. The system of claim 1, wherein the steam source is a component of the GOSP.

6. The system of claim 1, wherein the GOSP comprises a burner configured to provide heat to the steam source to generate the steam.

7. (canceled)

8. The system of claim 1, wherein the GOSP further comprises at least one member selected from the group consisting of a dehydrator and a desalter, wherein the at least one member is between the outlet of the degassing tank and the inlet of the dry oil tank.

9. The system of claim 8, wherein the steam source is a component of the GOSP.

10. The system of claim 9, wherein the conduit is an offshore trunk line that is directly connected to the GOSP inlet.

11. The system of claim 1, wherein the system is configured so that, during use of the system, the steam heats the crude in the conduit to a temperature of at least 125° F.

12. The system of claim 1, wherein the system is configured so that during use of the system:
before the steam is provided to the crude, the crude has a first water content;
after the steam is provided to the crude, the crude has a second water content; and
the second water content is at most 30% of the first water content.

13. The system of claim 1, wherein the system is configured so that, during use of the system after the steam is provided to the crude, the crude has a salt content of at most 10 parts per thousand barrels.

14.-20. (canceled)

21. The system of claim 1, wherein the production trap is configured to at least partially separate the crude, gas and water in the first fluid from each other.

22. The system of claim 21, wherein the production trap is configured to generate a first stream comprising the at least partially separated crude, a second stream comprising the at least partially separated gas and a third stream comprising the at least partially separated water.

23. The system of claim 22, wherein:
the production trap comprises a first production trap, a second production trap and a third production trap; and
each of the first, second and third production traps are configured to produce the first stream, the second stream, and the third stream.

24. The system of claim 22, wherein:
the degassing tank receives the first stream; and
the degassing tank is configured to remove gas from the first stream to provide a fourth stream, the fourth stream comprising the crude.

25. The system of claim 24, further comprising a dehydrator between the outlet of the degassing tank and the inlet of the dry oil tank, wherein:
the dehydrator receives the fourth stream; and
the dehydrator is configured to remove water from the fourth stream to provide a fifth stream, the fifth stream comprising the crude.

26. The system of claim 25, further comprising a desalter between an outlet of the dehydrator and the inlet of the dry oil tank, wherein:
the desalter receives the fifth stream; and
the desalter is configured to remove salt from the fifth stream.

27. The system of claim 24, further comprising a desalter between the outlet of the degassing tank and the inlet of the dry oil tank, wherein:
the desalter receives the fourth stream; and
the desalter is configured to remove salt from the fourth stream to provide a fifth stream, the fifth stream comprising the crude.
